(19) United States
(12) Patent Application Publication
(10) Pub. No.: US 2020/0301558 A1
(43) Pub. Date: Sep. 24, 2020

(54) TOUCH DISPLAY DEVICE AND MANUFACTURING METHOD THEREOF

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN)

(72) Inventors: Hongqiang LUO, Beijing (CN); Hairui ZHAO, Beijing (CN); Jianjun WU, Beijing (CN)

(21) Appl. No.: 16/753,558

(22) PCT Filed: May 22, 2019
(86) PCT No.: PCT/CN2019/087991

§ 371 Date: Apr. 3, 2020

(30) Foreign Application Priority Data
May 25, 2018 (CN) 201820800606.7

(51) Int. Cl. G06F 3/041; G06F 1/16; G06F 3/044

(52) U.S. Cl. CPC G06F 3/04164; G06F 1/1652; G06F 1/1643; G06F 2203/04102; G06F 3/0412; G06F 2203/04103; G06F 3/044

(57) ABSTRACT

The present disclosure provides a touch display device and a manufacturing method thereof. The touch display device includes a display panel, a touch panel, and a touch driver circuit for driving the touch panel, the touch panel being disposed on a light emitting side of the display panel, wherein the touch display device further includes a first flexible connection plate, a second flexible connection plate and a third flexible connection plate, a binding end is disposed on the first flexible connection plate or the display panel, an output end of the touch driver circuit is electrically connected to the binding end via a first trace with the binding end on the light emitting side of the display panel, and the binding end is electrically connected to an input end of the touch panel via the third flexible connection plate.

### CROSS-REFERENCE TO RELATED APPLICATION

The present application claims priority from Chinese patent application No. 201820800606.7 titled “A TOUCH DISPLAY DEVICE” filed with China Patent Office on May 25, 2018, the disclosure of which is incorporated herein by reference.

### TECHNICAL FIELD

The present disclosure relates to the technical field of touch display technologies, in particularly to a touch display device and a manufacturing method thereof.

### BACKGROUND

With the continuous development of touch display technologies, the demands and standards of consumers for touch display screens are also gradually increased. Touch display devices with a narrow bezel screen has become the mainstream of current touch research. With the rise of the OLED technology, the ultra-narrow bezel OLED touch display technology has become a major market for manufacturers in the world display field to compete.

Therefore, how to further narrow the bezel of the touch display device is an urgent technical problem to be solved in the field.

### SUMMARY

In an aspect of the present disclosure, there is provided a touch display device, including a display panel, a touch panel, and a touch driver circuit for driving the touch panel, the touch panel being disposed on a light emitting side of the display panel, wherein the touch display device further includes a first flexible connection plate, a second flexible connection plate and a third flexible connection plate, the first flexible connection plate has one end disposed on a back side facing away from the light emitting side of the display panel and the other end connected to the light emitting side of the display panel, and the second flexible connection plate is disposed on the back side of the display panel and connected to the first flexible connection plate; and the touch driver circuit is disposed on the second flexible connection plate, a first trace is disposed on the first flexible connection plate, a binding end is disposed on the first flexible connection plate or the display panel, an output end of the touch driver circuit is electrically connected to the binding end via the first trace with the binding end on the light emitting side of the display panel, and the binding end is electrically connected to an input end of the touch panel via the third flexible connection plate.

Optionally, the touch display device further includes a display driver circuit for driving the display panel disposed on the second flexible connection plate, and a second trace for electrically connecting the display driver circuit to an input end of the display panel is disposed on the second flexible connection plate.

Optionally, the second flexible connection plate includes a main flexible connection plate and a chip on film connected to the main flexible connection plate and the first flexible connection plate, the touch driver circuit is disposed on the main flexible connection plate, and the first trace is disposed on the main flexible connection plate, the chip on film and the first flexible connection plate; and the display driver circuit is disposed on the chip on film, and the second trace is disposed on the chip on film and the first flexible connection plate.

Optionally, the display panel includes an organic light emitting diode display panel.

Optionally, the touch display device includes a polarizer disposed on a surface of the touch panel facing away from the display panel.

Optionally, the touch display device includes a protective cover plate disposed on a light emitting side of the polarizer.

Optionally, the touch display device further includes a first transparent adhesive layer disposed between the protective cover plate and the polarizer to bond the protective cover plate and the polarizer together.

Optionally, the touch display device includes a second transparent adhesive layer disposed between the touch panel and the display panel to bond the touch panel on the display panel.

Optionally, the touch display device further includes a heat sink attached to the back side of the display panel and to which one end of the first flexible connection plate is fixedly connected.

Optionally, the touch display device includes a third adhesive layer disposed between the first flexible connection plate and a side of the heat sink facing away from the display panel.

Optionally, the binding end is disposed at a portion of the display panel to which the first flexible connection plate is connected.

In another aspect of the present disclosure, there is provided a manufacturing method of a touch display device, the touch display device including a display panel, a touch panel, a touch driver circuit for driving the touch panel, a first flexible connection plate, a second flexible connection plate and a third flexible connection plate, the first flexible connection plate having a first end connected to the display panel, wherein the manufacturing method includes: connecting a second end of the first flexible connection plate to the second flexible connection plate, and disposing the touch driver circuit on the second flexible connection plate, bonding the touch panel to a light emitting side of the display panel, connecting the third flexible connection plate electrically connected to an input end of the touch panel to a binding end, wherein the binding end is disposed on the first flexible connection plate or on the display panel on the light emitting side of the display panel, and an output end of the touch driver circuit is electrically connected to the binding end via a first trace disposed on the first flexible connection plate, and bonding, by bending the first flexible connection plate, the second end of the first flexible connection plate to a back side of the display panel facing away from the light emitting side of the display panel.

Optionally, the manufacturing method further includes: disposing a display driver circuit for driving the display panel on the second flexible connection plate, wherein a second trace for electrically connecting the display driver circuit to an input end of the display panel is disposed on the second flexible connection plate.

Optionally, the manufacturing method further includes: bonding a polarizer on a surface of the touch panel facing away from the display panel, bonding a protective cover plate to a light emitting side of the polarizer, and attaching a heat sink to the back side of the display panel, the first flexible connection plate having a second end fixedly connected to the heat sink.

### BRIEF DESCRIPTION OF THE DRAWINGS

Accompanying drawings are provided for further understanding of this disclosure and constitute a part of the description. Hereinafter, these drawings are intended to explain the disclosure together with the following exemplary embodiments, but should not be considered as a limitation of the disclosure. In the drawings:

FIG. 1 is a schematic structural side view of a touch display device provided in the related art in a bent state;

FIG. 2 is a schematic structural side view of a touch display device provided in the present disclosure in a bent state;

FIG. 3 is a schematic structural top view of the touch display device provided in the present disclosure in an extended state; and

FIG. 4 is a block diagram illustrating a manufacturing method for the touch display device provided in the present disclosure.

### DETAILED DESCRIPTION OF THE EMBODIMENTS

Hereinafter, specific embodiments of the present disclosure will be described with respect to the accompanying drawings. It will be appreciated that the specific embodiments as set forth herein are merely for the purpose of illustration and explanation of the disclosure and should not be constructed as a limitation thereof.

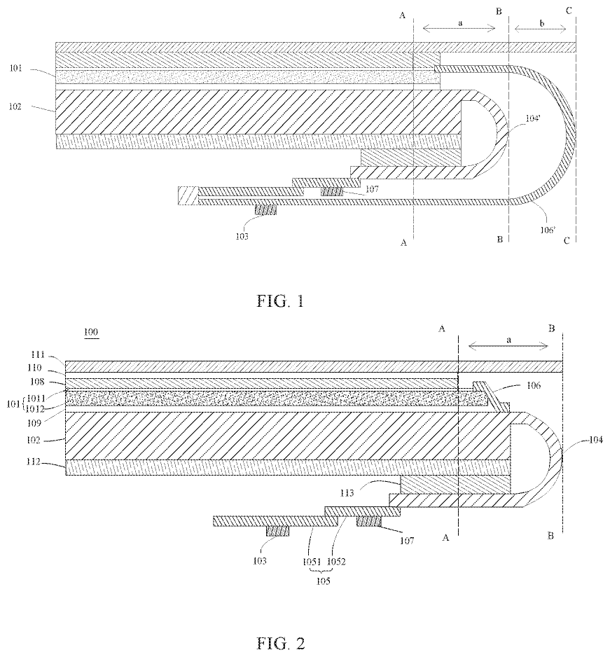

FIG. 1 shows a touch display device provided in the related art. The touch display device includes a touch panel 101 and a display panel 102. To drive the touch panel 101 and the display panel 102, the touch display device further includes a touch driver circuit 103 and a display driver circuit 107, where the touch driver circuit 103 is connected to the touch panel 101 via a flexible circuit board 106′ for touch.

Further, as shown in FIG. 1, a display area of the touch display device is located at a left side of the display edge line AA, and a bezel area of the touch display device is located at a right side of the display edge line AA. The bezel area includes a first bending area and a second bending area. Specifically, a first bending area edge line BB is formed by a tangent line parallel to the display edge line AA passing through the outermost bending point of a flexible connection plate 104′ for display, and a second bending area edge line CC is formed by a tangent line parallel to the display edge line AA passing through the outermost bending point of the flexible connection plate 106′ for touch. A distance from the edge line AA to the first bending area edge line BB is a; and a distance from the first bending area edge line BB to the second bending area edge line CC is b; that is to say, a bezel width of the touch display device is at least a+b, which is hard to satisfy the requirement of a narrow bezel.

As an aspect of the present disclosure, there is provided a touch display device. As shown in FIG. 2, the touch display device 100 includes a display panel 102, a touch panel 101 and a touch driver circuit 103 for driving the touch panel 101. The touch panel 101 is disposed on a light emitting side of the display panel 102. The touch display device 100 includes a first flexible connection plate 104, a second flexible connection plate 105, and a third flexible connection plate 106. The first flexible connection plate 104 has one end disposed on a back side facing away from the light emitting side of the display panel 102 and the other end connected to the light emitting side of the display panel 102. The second flexible connection plate 105 is disposed on the back side of the display panel 102 and connected to the first flexible connection plate 104.

The touch driver circuit 103 is disposed on the second flexible connection plate 105, a first trace is disposed on the first flexible connection plate 104, a binding end is disposed on the first flexible connection plate 104 or the display panel 102, an output end of the touch driver circuit 103 is electrically connected to the binding end via the first trace with the binding end on the light emitting side of the display panel 102, and the binding end is electrically connected to an input end of the touch panel 101 via the third flexible connection plate 106.

Firstly, it should be noted that for the touch panel 101 disposed on the light emitting side of the display panel 102, the “back side” and “light emitting side” of the display panel are both exemplified in FIG. 2, where a side of the display panel 102 away from the touch panel 101 is defined as the back side of the display panel 102, and a side of the display panel 102 facing the touch panel 101 is defined as the light emitting side of the display panel 102. Obviously, the above definitions are only for facilitating understanding of the technical solutions of the present disclosure by those skilled in the art, and do not configure any limitation to the present disclosure.

As described above, the first flexible connection plate 104 is connected to and disposed between the second flexible connection plate 105 and the display panel 102, and configured to enable electrical connection of the touch driver circuit 103 and the touch panel 101.

Specifically, the first flexible connection plate 104 has one end disposed on a back side facing away from the light emitting side of the display panel 102 and the other end connected to the light emitting side of the display panel 102, while the second flexible connection plate 105 is disposed on the back side of the display panel 102. Then, the one end of the first flexible connection plate 104 disposed on the back side of the display panel 102 is connected to the second flexible connection plate 105.

Further, a first trace (not shown) is disposed on the first flexible connection plate 104, a binding end (not shown) is disposed on the first flexible connection plate 104 or the display panel 102, an output end of the touch driver circuit 103 may be electrically connected to the binding end via the first trace, and the binding end may be electrically connected to an input end of the touch panel 101 via the third flexible connection plate 106, thereby enabling electrical connection of the touch driver circuit 103 and the touch panel 101 and thus ensuring normal operation of the touch display device 100. It should be noted that the binding end is configured to be electrically connected to the output end of the touch driver circuit and the input end of the touch panel, respectively. As an alternative embodiment of the present disclosure, the binding end may be a touch bonding pin.

It should be noted that, since the binding end is located on the light emitting side of the display panel 102, when the binding end is disposed on the first flexible connection plate 104, the binding end may be located at one of the two ends of the first flexible connection plate 104 which is located on the light emitting side of the display panel 102. Obviously, the binding end may also be disposed at other positions of the first flexible connection plate 104 as long as the binding end is located on the light emitting side of the display panel 102. As an alternative embodiment of the present disclosure, the binding end may be disposed at a portion of the first flexible connection plate 104 to which the display panel 102 is connected. Alternatively, as another alternative embodiment of the present disclosure, the binding end may be disposed on the display panel 102. Specifically, the binding end may be disposed at a portion of the display panel to which the first flexible connection plate is connected so that the third flexible connection plate 106 may be designed to have a shorter length. Via the third flexible connection plate 106, the input end of the touch panel 101 is electrically connected to the binding end, while the first flexible connection plate 104 is electrically connected to the light emitting side of the display panel 102, thereby enabling electrical connection of the touch driver circuit 103 and the touch panel 101.

In summary, by disposing the touch driver circuit on the second flexible connection plate, electrically connecting the second flexible connection plate to the first flexible connection plate, disposing a binding end on the first flexible connection plate or the display panel on the light emitting side of the display panel with the binding end on the light emitting side of the display panel, and by electrically connecting the third flexible connection plate to the input end of the touch panel and the binding end to enable electrical connection of the touch panel and the touch driver circuit, the present disclosure avoids direct electrical connection between the input end of the touch panel and the output end of the touch driver circuit so that the length of the third flexible connection plate is greatly reduced, the bezel width generated by bending the third flexible connection plate is further reduced or even eliminated, which facilitates a narrow bezel design of the touch display device, and reduces the manufacturing cost.

The touch display device of the present disclosure is as shown in FIG. 2, in which the third flexible connection plate 106 is located on the light emitting side of the display panel 102, and there is no bent portion of the flexible circuit board 106′ for touch as in the related art shown in FIG. 1, thereby eliminating the bezel width b. In the parameter indexes of the related art, a typically ranges from 2500 μm to 2700 μm, while b ranges from 300 μm to 500 μm. That is, the bezel width of the touch display device obtained from the technical solution of the disclosure is at least 300 μm less than that of the touch display device in the related art.

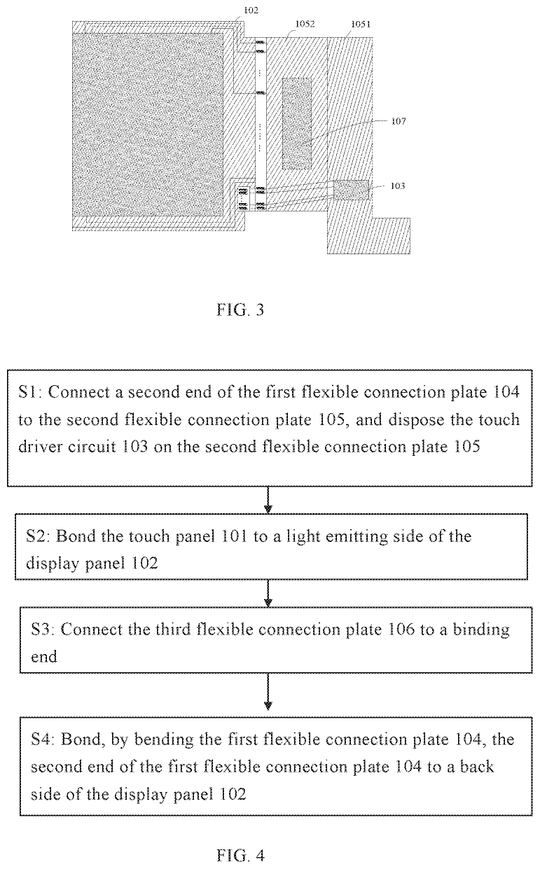

In the present disclosure, as shown in FIGS. 2 and 3, the touch display device 100 further includes a display driver circuit 107 for driving the display panel 102 disposed on the second flexible connection plate 105, and a second trace for electrically connecting the display driver circuit 107 to the input end of the display panel 102 is disposed on the second flexible connection plate 105.

As described above, the second flexible connection plate 105 is provided with a second trace for electrically connecting the display driver circuit 107 disposed on the second flexible connection plate 105 to the input end of the display panel 102, so as to ensure normal operation of the display panel 102. It will be appreciated that although the second flexible connection plate 105 is provided with the second trace, the second trace is not only disposed on the second flexible connection plate 105. Depending on different positions of the input end of the display panel 102, the second trace may also be disposed on the first flexible connection plate 104 and the display panel 102.

Further, in the present disclosure, as shown in FIGS. 2 and 3, the second flexible connection plate 105 includes a main flexible connection plate 1051 and a chip on film (COF) 1052 connected to the main flexible connection plate 1051 and the first flexible connection plate 104.

The touch driver circuit 103 is disposed on the main flexible connection plate 1051, and the first trace is disposed on the main flexible connection plate 1051, the chip on film 1052 and the first flexible connection plate 104.

The display driver circuit 107 is disposed on the chip on film 1052, and the second trace is disposed on the chip on film 1052 and the first flexible connection plate.

As described above, the touch driver circuit 103 is disposed on the main flexible connection plate 1051, and in order to enable electrical connection of the touch driver circuit 103 and the touch panel 101, the first trace further includes, in addition to the portion disposed on the first flexible connection plate, a portion disposed on the main flexible connection plate 1051 and a portion disposed on the chip on film 1052.

Similarly, in order to enable electrical connection of the display driver circuit 107 and the input end of the display panel 102, the second trace includes a portion disposed on the chip on film 1052, and a portion disposed on the first flexible connection plate 104.

It should be noted that the main flexible connection plate 1051 and the chip on film 1052 are bound by an anisotropic conductive adhesive, thereby ensuring relatively fixed positions of the main flexible connection plate 1051 and the chip on film 1052 while cooperating with the first trace and the second trace for normal operation. Similarly, the chip on film 1052 and the first flexible connection plate 104 may also be bound by an anisotropic conductive adhesive to achieve relatively fixed positions.

As a preferred embodiment of the present disclosure, the display panel 102 may be an organic light emitting diode display panel.

The touch driver circuit 103 may include a touch driver chip; and the display driver circuit 107 may include a display driver chip.

In the present disclosure, as shown in FIG. 2, the touch display device 100 includes a polarizer 108 disposed on a surface of the touch panel 101 facing away from the display panel 102.

As described above, the polarizer 108 is disposed on the light emitting side of the display panel 102. Specifically, the polarizer 108 is attached to a surface of the touch panel facing away from the light emitting side of the display panel.

As an alternative embodiment of the present disclosure, the display panel 102 is selected to be an organic light emitting diode display panel, and the polarizer 108 is selected to be an ¼ wave plate mainly used for preventing light reflection on the light emitting side of the touch display device.

As still another alternative implementation manner of the present disclosure, as shown in FIG. 2, the touch panel 101 includes a touch electrode 1011 and a touch substrate 1012.

In the present disclosure, as shown in FIG. 2, the touch display device 100 includes a protective cover plate 111 disposed on a light emitting side of the polarizer 108.

As described above, the protective cover plate 111 is disposed on the outermost side of the light emitting surface of the entire touch display device 100, so as to protect internal structures of the touch display device 100.

Further, in the present disclosure, the touch display device 100 further includes a first transparent adhesive layer 110 disposed between the protective cover plate 111 and the polarizer 108 to bond the protective cover plate 111 and the polarizer 108 together.

As described above, the first transparent adhesive layer 110 is disposed between the protective cover plate 111 and the polarizer 108. Specifically, the first transparent adhesive layer 110 is respectively attached to a light emitting surface of the polarizer 108 and a light incident surface of the protective cover plate, so as to bond the protective cover plate 111 and the polarizer 108 together and achieve relatively fixed positions of the two.

As an alternative embodiment of the present disclosure, the first transparent adhesive layer may also be a transparent optical tape.

Further, in the present disclosure, as shown in FIG. 2, the touch display device 100 includes a second transparent adhesive layer 109 disposed between the touch panel 101 and the display panel 102 to bond the touch panel on the display panel.

As an alternative embodiment of the present disclosure, the second transparent adhesive layer 109 may also be a transparent optical tape.

In the present disclosure, as shown in FIG. 2, the touch display device 100 further includes a heat sink 112 attached to the back side of the display panel 102 and to which one end of the first flexible connection plate 104 is fixedly connected.

It is easy to understand that, since the display panel 102 generates heat during operation, if the temperature of the display panel 102 increases due to delayed heat dissipation, the service life of the display panel 102 may be affected by the long-term high temperature status. Therefore, in the present disclosure, the heat sink 112 is attached to the back of the display panel 102 so that the heat in the display panel 102 is transferred out timely through the heat sink 112 and thus the temperature of the display panel is reduced.

By fixedly connecting an end of the first flexible connection plate 104 opposite to the binding end with the heat sink 112, the bezel width of the touch display device 100 can be effectively reduced and compressed, thereby enabling a narrow bezel. Specifically, the first flexible connection plate 104, along a length direction thereof, has one end connected to the light emitting side of the display panel, and the other end fixedly connected to the heat sink 112 so that the first flexible connection plate 104 is bent, and then the touch driver circuit 103 and the display driver circuit 107 can be disposed on the back of the display panel 102, thereby realizing the narrow bezel design of the touch display device 100.

Further, as an alternative embodiment of the present disclosure, in the present disclosure, as shown in FIG. 2, the touch display device 100 includes a third adhesive layer 113 disposed between the first flexible connection plate 104 and a side of the heat sink 112 facing away from the display panel 102.

It is easy to understand that the provision of the third adhesive layer 113 can realize fixed connection between one end of the first flexible connection plate 104 and the heat sink 112, and further secure the touch driver circuit 103 and the display driver circuit 107 disposed on the back of the display panel 102, and finally achieve the purpose of narrow bezel design of the touch display device 100.

As an alternative embodiment of the present disclosure, the heat sink may be made of a metal material with good heat dissipation performance, and the third adhesive layer 113 may be a foam adhesive.

As another aspect of the present disclosure, there is provided a manufacturing method of a touch display device. The touch display device 100 includes a display panel 102, a touch panel 101, a touch driver circuit 103 for driving the touch panel, a first flexible connection plate 104, a second flexible connection plate 105, and a third flexible connection plate 106, the first flexible connection plate 104 having a first end connected to the display panel 102. The manufacturing method includes:

S1: connecting a second end of the first flexible connection plate 104 to the second flexible connection plate 105, and disposing the touch driver circuit 103 on the second flexible connection plate 105;

S2: bonding the touch panel 101 to a light emitting side of the display panel 102;

S3: connecting the third flexible connection plate 106 electrically connected to an input end of the touch panel 101 to a binding end, wherein the binding end is disposed on the first flexible connection plate 104 or on the display panel 102 on the light emitting side of the display panel 102, and an output end of the touch driver circuit 103 is electrically connected to the binding end via a first trace disposed on the first flexible connection plate 104; and

S4: bonding, by bending the first flexible connection plate 104, the second end of the first flexible connection plate 104 to a back side of the display panel 102 facing away from the light emitting side of the display panel 102.

By reserving the binding end on the first flexible connection plate 104 or the display panel 102, and integrating the output end of the touch driver circuit 103 on the second flexible connection plate 105, a length of the third flexible connection plate 106 which plays a switching role can be reduced. The third flexible connection plate 106 (for switching) connected to the input end of the touch panel 101 is directly connected to the first flexible connection plate 104 or the light emitting side of the display panel 102. Therefore, the length of the third flexible connection plate is greatly reduced, the bezel width generated by bending the third flexible connection plate is further reduced or even eliminated, which facilitates a narrow bezel design of the touch display device, and reduces the manufacturing cost. As an alternative embodiment of the present disclosure, the manufacturing method may further include: disposing a display driver circuit 107 for driving the display panel 102 on the second flexible connection plate 105. A second trace for electrically connecting the display driver circuit 107 to the input end of the display panel 102 is disposed on the second flexible connection plate 105.

As an alternative embodiment of the present disclosure, the manufacturing method may further include: bonding a polarizer 108 on a surface of the touch panel 101 facing away from the display panel 102,

bonding a protective cover plate 111 to a light emitting side of the polarizer 108, and

attaching a heat sink 112 to the hack side of the display panel 102, the second end of the first flexible connection plate 104 being fixedly connected to the heat sink 112.

It will be appreciated that the adhesion may be implemented by a transparent optical tape or a foam adhesive. In addition, the steps of the above manufacturing method are not limited to a strict order as long as the touch display device can be manufactured.

It will be appreciated that the above embodiments are merely exemplary embodiments for the purpose of illustrating the principle of the present disclosure, and the present disclosure is not limited thereto. Various modifications and improvements can be made by a person having ordinary skill in the art without departing from the spirit and essence of the disclosure. Accordingly, all of the modifications and improvements also fall into the protection scope of the disclosure.

1. A touch display device, comprising a display panel, a touch panel, and a touch driver circuit for driving the touch panel, the touch panel being disposed on a light emitting side of the display panel,
wherein the touch display device further comprises a first flexible connection plate, a second flexible connection plate and a third flexible connection plate, the first flexible connection plate has one end disposed on a back side facing away from the light emitting side of the display panel and the other end connected to the light emitting side of the display panel, and the second flexible connection plate is disposed on the back side of the display panel and connected to the first flexible connection plate; and
the touch driver circuit is disposed on the second flexible connection plate, a first trace is disposed on the first flexible connection plate, a binding end is disposed on the first flexible connection plate or the display panel, an output end of the touch driver circuit is electrically connected to the binding end via the first trace with the binding end on the light emitting side of the display panel, and the binding end is electrically connected to an input end of the touch panel via the third flexible connection plate.

2. The touch display device according to claim 1, wherein the touch display device further comprises a display driver circuit for driving the display panel disposed on the second flexible connection plate, and a second trace for electrically connecting the display driver circuit to an input end of the display panel is disposed on the second flexible connection plate.

3. The touch display device of claim 2, wherein the second flexible connection plate comprises a main flexible connection plate and a chip on film connected to the main flexible connection plate and the first flexible connection plate,
the touch driver circuit is disposed on the main flexible connection plate, and the first trace is disposed on the main flexible connection plate, the chip on film and the first flexible connection plate; and
the display driver circuit is disposed on the chip on film, and the second trace is disposed on the chip on film and the first flexible connection plate.

4. The touch display device according to claim 1, wherein the display panel comprises an organic light emitting diode display panel.

5. The touch display device according to claim 4, wherein the touch display device comprises a polarizer disposed on a surface of the touch panel facing away from the display panel.

6. The touch display device according to claim 5, wherein the touch display device comprises a protective cover plate disposed on a light emitting side of the polarizer.

7. The touch display device according to claim 6, wherein the touch display device further comprises a first transparent adhesive layer disposed between the protective cover plate and the polarizer to bond the protective cover plate and the polarizer together.

8. The touch display device according to claim 7, wherein the touch display device comprises a second transparent adhesive layer disposed between the touch panel and the display panel to bond the touch panel on the display panel.

9. The touch display device according to claim 8, wherein the touch display device further comprises a heat sink attached to the back side of the display panel and to which one end of the first flexible connection plate is fixedly connected.

10. The touch display device according to claim 9, wherein the touch display device comprises a third adhesive layer disposed between the first flexible connection plate and a side of the heat sink facing away from the display panel.

11. The touch display device according to claim 10, wherein the binding end is disposed at a portion of the display panel to which the first flexible connection plate is connected.

12. A manufacturing method of a touch display device, the touch display device comprising a display panel, a touch panel, a touch driver circuit for driving the touch panel, a first flexible connection plate, a second flexible connection plate and a third flexible connection plate, the first flexible connection plate having a first end connected to the display panel, wherein the manufacturing method comprises:
connecting a second end of the first flexible connection plate to the second flexible connection plate, and disposing the touch driver circuit on the second flexible connection plate,
bonding the touch panel to a light emitting side of the display panel,
connecting the third flexible connection plate electrically connected to an input end of the touch panel to a binding end, wherein the binding end is disposed on the first flexible connection plate or on the display panel on the light emitting side of the display panel, and an output end of the touch driver circuit is electrically connected to the binding end via a first trace disposed on the first flexible connection plate; and
bonding, by bending the first flexible connection plate, the second end of the first flexible connection plate to a back side of the display panel facing away from the light emitting side of the display panel.

13. The manufacturing method according to claim 12, further comprising:
disposing a display driver circuit for driving the display panel on the second flexible connection plate, wherein a second trace for electrically connecting the display driver circuit to an input end of the display panel is disposed on the second flexible connection plate.

14. The manufacturing method according to claim 13, further comprising:
bonding a polarizer on a surface of the touch panel facing away from the display panel,
bonding a protective cover plate to a light emitting side of the polarizer, and
attaching a heat sink to the back side of the display panel, the first flexible connection plate having a second end fixedly connected to the heat sink.
